(19) United States
(12) Patent Application Publication
(10) Pub. No.: US 2022/0296012 A1
(43) Pub. Date: Sep. 22, 2022

(54) Blanket for Filtering Airborne Pathogens

(71) Applicant: Jose Davadi, Richmond, VA (US)

(72) Inventor: Jose Davadi, Richmond, VA (US)

(21) Appl. No.: 17/694,844

(22) Filed: Mar. 15, 2022

Related U.S. Application Data
(60) Provisional application No. 63/163,095, filed on Mar. 19, 2021.

(51) Int. Cl. A47G 9/00; A47G 9/02

(52) U.S. Cl. CPC A47G 9/007; A47G 9/0223

(57) ABSTRACT

The present invention relates to a blanket lined with an airborne pathogens filtering layer. The blanket features fabric layers and one or more filtering layers disposed between fabric layers. In one embodiment, a single non-woven polypropylene filter layer is disposed and, in another embodiment, an ultraviolet ray protection layer and an airborne pathogen filtering layer is disposed between the fabric layers. The filter layer may be a N95, KN95 or PM2.5 filter layer and helps prevent harmful airborne pathogens from passing through the blanket and being inhaled by a child, effectively reducing the chance of contracting an illness.

### CROSS-REFERENCE TO RELATED APPLICATION

The present application claims priority to, and the benefit of, U.S. Provisional Application No. 63/163,095, which was filed on Mar. 19, 2021, and is incorporated herein by reference in its entirety.

### FIELD OF THE INVENTION

The present invention relates generally to the field of protective clothing and accessories. More specifically, the invention relates to a blanket that has an embedded airborne pathogens filtering layer for protecting children, infants and adults on whom the blanket is placed from inhaling harmful germs, viruses, bacteria and other airborne pathogens. The blanket eliminates the need for a child to wear a facemask when lying in a stroller, car seat, basinet, crib, child swing or other carrier, for example, and can filter airborne pathogens up to the size of about 0.3 microns. Accordingly, the present disclosure makes specific reference thereto. Nonetheless, it is to be appreciated that aspects of the present invention are also equally applicable to other like applications, devices and methods of manufacture.

### BACKGROUND

By way of background, a face mask is a product that covers the wearer's nose and mouth and worn by people for protection from pathogens, germs, viruses and other diseases. Facemasks maximize protection and prevent transmission of pathogens to others and are effective in preventing the transmission of highly communicable diseases such as COVID-19. Various types of facemasks are available, including medical or surgical masks for protecting the wearer from contact with airborne droplets and sprays that may contain germs. A surgical mask is a loose-fitting, disposable personal protection device that creates a physical barrier between the mouth and nose of the wearer and potential contaminants in the immediate environment. A KN95 mask is a type of respirator that offers more protection than a conventional medical mask, as the KN95 mask filters out both large and small particles when the wearer inhales. An N95 mask is a type of respirator that offers the highest level of protection. The N95 mask is designed to achieve a very close facial fit and very efficient filtration of airborne particles.

Facemasks can be easily worn by adults for protection but keeping a facemask on a child can be difficult. Moreover, WHO and UNICEF advise that children aged 5 years and under should not wear masks based on their capacity to appropriately use a mask with minimal assistance. This makes infants and young children susceptible to the spread of germs, viruses and bacteria.

Various other studies indicate that children under two years old should not wear facemasks because of suffocation risks. Therefore, children may lack protection from airborne pathogens. Parents and caretakers desire a device or a way to protect their infants and small children from pathogens without requiring children to wear facemasks.

Children having weak immune and respiratory systems especially require a protection mechanism from airborne pathogens, as such children cannot wear facemasks. Also, when parents or caretakers take their children outdoors in strollers, children lack protection from airborne pathogens and therefore desire a protective device that can protect the child from pathogens.

Children like to be swaddled in a blanket when going outdoors and even indoors. People would prefer to have an improved blanket that can also filter airborne pathogens and thus protect children from inhaling harmful germs, viruses, bacteria and other airborne particulates.

Therefore, there exists a long felt need in the art for a protective wrap or cover that can eliminate the requirement of having to wear facemasks by children, infants and toddlers, while providing effective protection from airborne pathogens and contaminants. There is also a long felt need in the art for a protective wrap or cover that protects children from inhaling harmful germs, pathogens, viruses and bacteria. Additionally, there is a long felt need in the art for an apparel or protective wrap or cover that does not create a suffocation risks for children. Moreover, there is a long felt need in the art for a blanket or protective wrap or cover that does not make infants and young children susceptible to the spread of germs, viruses, pathogens and bacteria. Finally, there is a long felt need in the art for a way to keep children safe from harmful airborne pathogens without having to constantly wear a face mask.

The subject matter disclosed and claimed herein, in one embodiment thereof, comprises a blanket or protective wrap or cover construction for filtering airborne contaminants. The blanket offers a way to keep children, infants and others protected from inhaling harmful germs, viruses, pathogens and bacteria without having to constantly wear a face mask. The blanket or protective wrap or cover features a first layer of fabric and a second layer of fabric. The first layer of fabric and the second layer of fabric are permanently sewn together along their periphery and are made from a soft, washable material. An N95 filter layer made from woven or non-woven polypropylene fiber is disposed between the first layer of fabric and the second layer of fabric for filtering airborne pathogens of size approximately about 0.3 micron through the N95 layer. The N95 filter layer is of substantially the same size as of the first layer of fabric and the second layer of fabric and is stitched together along the periphery of the layers.

In this manner, the blanket or protective cover or wrap of the present invention accomplishes all of the forgoing objectives and provides users with a unique and improved baby blanket lined with an N95 filter that protects children from inhaling harmful germs, viruses, pathogens and bacteria. The blanket or protective wrap enables parents to swaddle children in the blanket or place the blanket over the stroller or carrier and function as a filtering method between the child or infant and breathable air. The blanket or protective cover or wrap offers a way to keep children safe from harmful airborne pathogens without having to constantly wear a face mask.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a protective blanket, cover or wrap construction for filtering airborne contaminants. The blanket, cover or wrap offers a way to keep children and infants safe from contamination of harmful airborne pathogens without having to constantly wear a face mask. The blanket further includes a first layer of fabric and a second layer of fabric that are stitched along their periphery. A N95 filter layer which is made from polypropylene fiber disposed between the first layer of fabric and the second layer of fabric for filtering airborne pathogens of size 0.3+ micron through the N95 layer and the N95 filter layer is of substantially the same size as of the first layer of fabric and the second layer of fabric and stitched along the periphery. A portion of the periphery may have a zipper, snaps, hook and loop fasteners or other openings to allow the owner to remove the N95 material and replace it with a new filter material after the filter material has reached its life expectancy.

In yet another embodiment, the N95 filter layer can be woven or non-woven, and the blanket can be used as a swaddle blanket or a security blanket.

In yet another embodiment, a baby blanket for filtering airborne pathogens for providing safety to a child on whom the blanket, cover or wrap is placed is disclosed. The baby blanket has an ultraviolet light protection layer for protecting the child from harmful ultraviolet rays, and a spun-bound polypropylene layer for filtering airborne pathogens. The ultraviolet light protection layer and the spun-bound polypropylene layer are disposed between the two fabric layers such that the fabric layers can be made from the same or different fabric or materials.

In yet another embodiment, the baby blanket filters the majority of airborne pathogens having a particle size of at least about 0.3 micron to about 0.75 microns.

In yet another embodiment, a method for protecting a child, infant or toddler from inhaling harmful germs, viruses, and bacteria is described. The method includes providing a blanket, cover or wrap, having a filter layer that is disposed between fabric layers for filtering harmful germs, viruses, pathogens and bacteria. Next, the blanket, cover or wrap is placed over the child, infant or toddler, such that the face of the child, infant or toddler is covered by the blanket, cover or wrap, and filtering out harmful germs, viruses, pathogens and bacteria by said filter layer.

In yet another embodiment, a blanket, cover or wrap for filtering airborne pathogens is disclosed. The blanket includes a housing comprising two layers of fabric stitched or secured along the periphery, a zipper or opening along the periphery, a filter layer disposed between the layers of fabric and the filter layer is configured to filter airborne pathogens and has a length equal to one-fourth length of the layers. An insulating layer may also be provided to help keep the child or infant warm during cold weather periods.

In yet another embodiment, each of the fabric layers has a different color on one-fourth surface area for indicating presence of the filter layer between the fabric layers, and the fabric of the blanket can be one or more of microfleece, cashmere, cotton, wool, stretched polytetrafluoroethylene, polyester or linen materials.

In yet another embodiment, the blanket, cover or wrap is available in a plurality of colors and designs, and the blanket, cover or wrap is machine washable and reusable.

In yet another embodiment, the blanket, cover or wrap may have an insulating layer and indica provided on one or more of the outer layers. Further, numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the N95 filter lined blanket, cover or wrap of the present invention in accordance with the disclosed architecture;

FIG. 2 illustrates a perspective view showing a child or infant which is swaddled in the blanket, cover or wrap of the present invention in accordance with the disclosed architecture;

FIG. 3 illustrates a perspective view showing the N95 filter lined blanket, cover or wrap placed over child in a stroller, carrier, swing or other equipment to protect the child or infant from pathogens in accordance with the disclosed architecture;

FIG. 4 illustrates a perspective view of another potential embodiment of the N95 filter lined blanket, cover or wrap of the present invention in accordance with the disclosed architecture; and

FIG. 5 illustrates a perspective view of yet another potential embodiment of the blanket of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a protective cover, wrap or blanket that can eliminate the requirement of children, infants and toddlers having to wear facemasks while also providing effective protection from airborne pathogens. There is also a long felt need in the art for a device that protects children, infants and toddlers from inhaling harmful germs, viruses and bacteria. Additionally, there is a long felt need in the art for an article of apparel or other accessory that does not create suffocation risks for children. Moreover, there is a long felt need in the art for a blanket, cover or wrap that does not make infants and young children susceptible to the spread of germs, viruses and bacteria. Finally, there is a long felt need in the art for a way to keep children, infants and toddlers safe from harmful airborne pathogens without having to constantly wear a face mask.

The present invention, in one exemplary embodiment, is a novel method for providing a child, infant or toddler from inhaling harmful germs, viruses, and bacteria. The method includes providing a blanket, with the blanket having a filter layer that is disposed between fabric layers for filtering harmful germs, viruses and bacteria. Next, the blanket is placed over the child, infant or toddler such that the face of the child, infant or toddler is covered by blanket and filters out harmful germs, viruses, and bacteria by the filter layer.

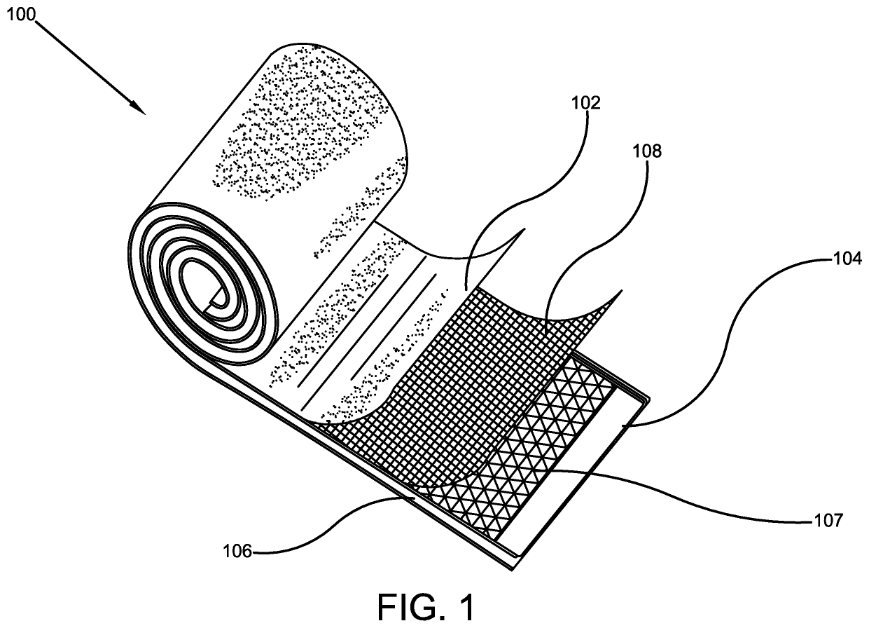

Referring initially to the drawings, FIG. 1 illustrates a perspective view of one potential embodiment of the N95 filter lined blanket, cover or wrap of the present invention in accordance with the disclosed specification. Other suitable filters include PM2.5 which prevent particles down to 2.5 microns, and as COVID-19 particles are usually contained in saliva the mask adequately filters out the virus. The N95 or other filter lined blanket 100 is designed as a fluffy, two-sided blanket, cover or wrap integrated with an N95 or other filter material between outer layers of blanket fabric. The blanket 100 can be used as a conventional blanket or a cover for swaddling an infant or a toddler, while the blanket 100 also provides protection against inhaling harmful germs, viruses and bacteria. More specifically, the N95 filter layer of the blanket 100 prevents harmful airborne pathogens from passing through the blanket 100 and being inhaled by the child, effectively reducing the chance of contracting an illness.

The blanket, cover or wrap 100 includes a first layer 102 of fabric and a second layer 104 of the fabric where the first layer 102 and the second layer 104 are stitched or otherwise bonded together at the periphery 106. The blanket, cover or wrap 100 may also include an insulating layer 107 which is provided for additional warmth during cold weather periods. The first layer 102 and the second layer 104 can be of same or different fabric selected from microfleece, cashmere, cotton, wool, stretched polytetrafluoroethylene, polyester, or linen materials. The blanket 100 further has a N95 or other filter material layer 108 sandwiched between the first layer 102 and the second layer 104.

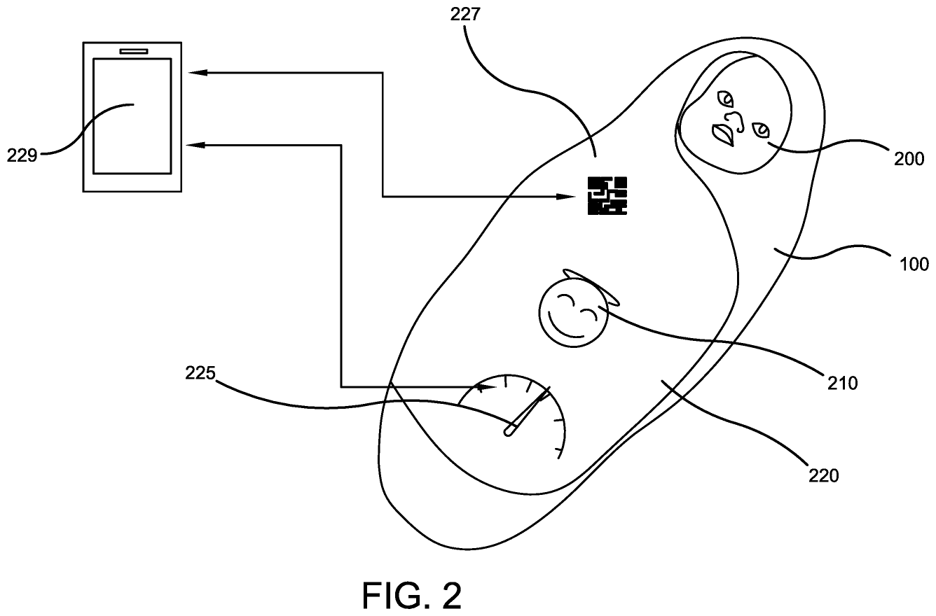

In one embodiment, the N95 layer 108 is substantially the same size as the first layer 102 and the second layer 104, and is stitched, secured or sewn around the periphery 106. The N95 or other filter layer 108 is preferably made from a flexible, breathable, shrink-resistant, tear-resistant, washable and electrostatic woven or non-woven polypropylene fiber. The periphery 106 may have a fluffy border for facilitating comfort to a child when applied on the child, and may include a zipper or other opening 220 (see FIG. 2) for removing the filter material when its useful life expectancy is over.

The blanket, cover or wrap 100 can function as both a swaddling blanket and a security blanket for infants, toddlers, and others. Further, the blanket 100 comes in a variety of colors, designs, and sizes and can be rolled for storage and transportation. The blanket 100 can be used outdoors, such as during air travel and all other public transportation, and is particularly useful to protect a child, infant or toddler from pathogens, droplets that may be transmitted from sick people and airborne pathogens.

The N95 or other filter layer 108 is configured to remove 95% of 0.3+ micron particles, while allowing gases and air to pass therethrough, thus not obstructing the breathing of a child user. In one embodiment, a single layer of non-woven polypropylene is disposed between the layers 102, 104. However, it is also contemplated that a plurality of filter layers can be disposed between the layers 102, 104. The filter material may also be provided in predetermined areas, such as those that would be over or near the face of the child.

FIG. 2 illustrates a perspective view showing a child swaddled in the blanket 100 of the present invention in accordance with the disclosed specification. More specifically, the blanket, cover or wrap 100 is used as a swaddling blanket, and a child 200 is swaddled in the blanket 100. The swaddling blanket 100 does not allow germs and pathogens to pass through, and protects the child 200 in both outdoor and indoor environments. The blanket 100 is especially useful for protecting the child 200 from contamination due to people having the flu or a cold. The blanket 100 is also useful for protecting against harmful gases. The blanket may have a zipper or other opening 220 to allow the filter material to be removed when it has reached the end of its useful life. Indicia or graphics 210 may also be added to the blanket and a gauge 225 or other indicator 227, such as a RFID tag, may be provided so that the parent or guardian is notified when it is time to replace the filter material. Other indicators, such as a RFID tag 227, may be used to help locate the blanket 100 if it is lost. The gauge 225 or other indicator 227 may also be connected to a smart phone 229 or other device that has a downloaded application thereon to allow tracking of the blanket 100 and the appropriate replacement time for the filter material. Either indicator may have a visual indication so that if the smartphone application is not in use, the parent, guardian or sitter can see the color change indication. The application may also include an alarm when a number of hours has elapsed, thereby requiring that the filter be changed.

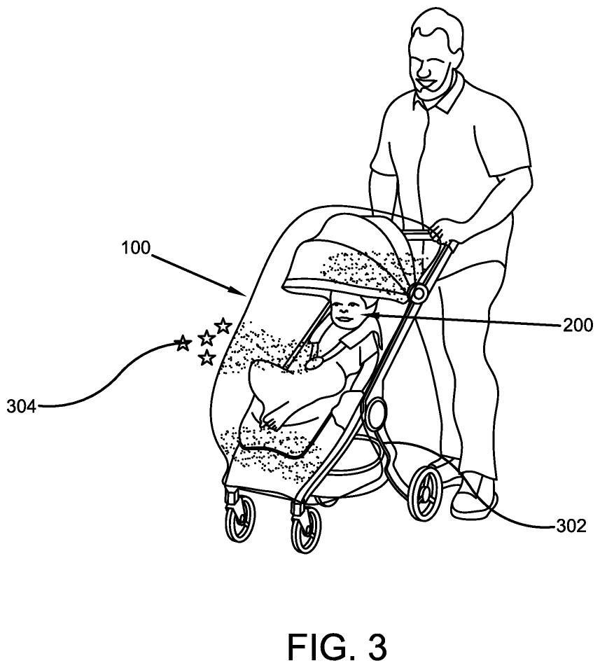

FIG. 3 illustrates a perspective view of the N95 filter lined blanket 100 placed over a child in a stroller to protect the child from pathogens in accordance with the disclosed specification. As shown, the pathogen protecting blanket 100 may be placed over the child 200 when the child 200 is lying in the stroller 302. The blanket 100 acts as a shield for harmful gases, airborne pathogens and any other viruses referenced through numeral 304, and thereby protects the child 200. The blanket 100 also eliminates the need for the child 200 to wear a conventional facemask, and is therefore more convenient and effective. The pathogen protecting blanket 100 does not obstruct breathing, and does not restrict oxygen from reaching the child 200. The blanket 100 is also reversible, meaning that either of the two layers of fabric can safely and comfortably contact the skin of the child 200.

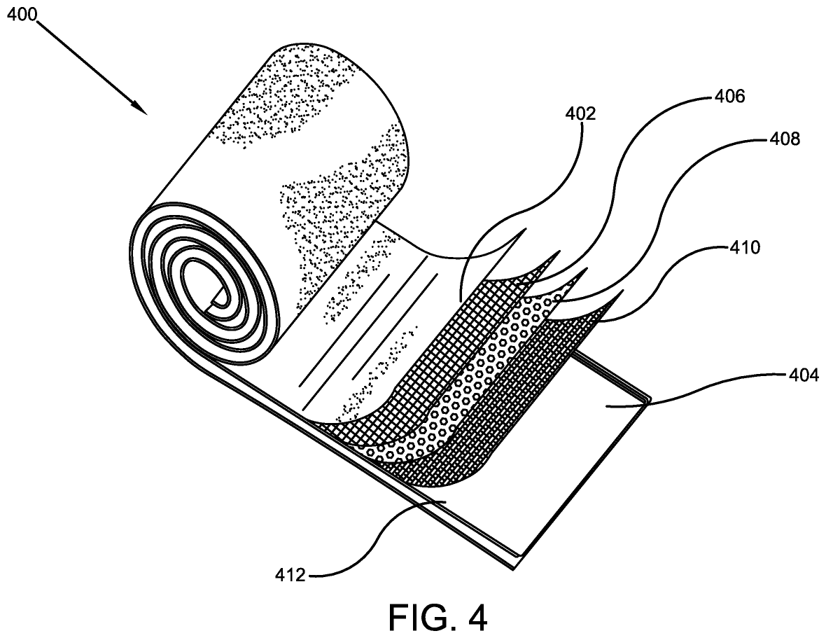

FIG. 4 illustrates a perspective view of another potential embodiment of the N95 filter lined blanket of the present invention in accordance with the disclosed specification. In the present embodiment, the baby blanket 400 has a first outer fabric layer 402 and a second outer fabric layer 404 with a plurality of filter layers disposed between the first outer fabric layer 402 and the second outer fabric layer 404. The blanket 400 is especially designed for use in an outdoor environment, and is also configured to protect the user from harmful ultraviolet rays. More specifically, the blanket 400 has an ultraviolet (UV) rays protection layer 406 for protection from harmful UV rays. The layers 408, 410 protect from harmful pathogens and germs, wherein the layer 408 is preferably comprised of a spun-bond polypropylene and the layer 410 is preferably comprised of a cellulose or polyester.

The layers 406, 408, 410 are breathable, and do not obstruct passage of air. Further, the layers 406, 408, 410 can be adhered to each other using an adhesive (not shown), or can be stitched or otherwise adhered or secured together along the periphery 412 of the blanket 400.

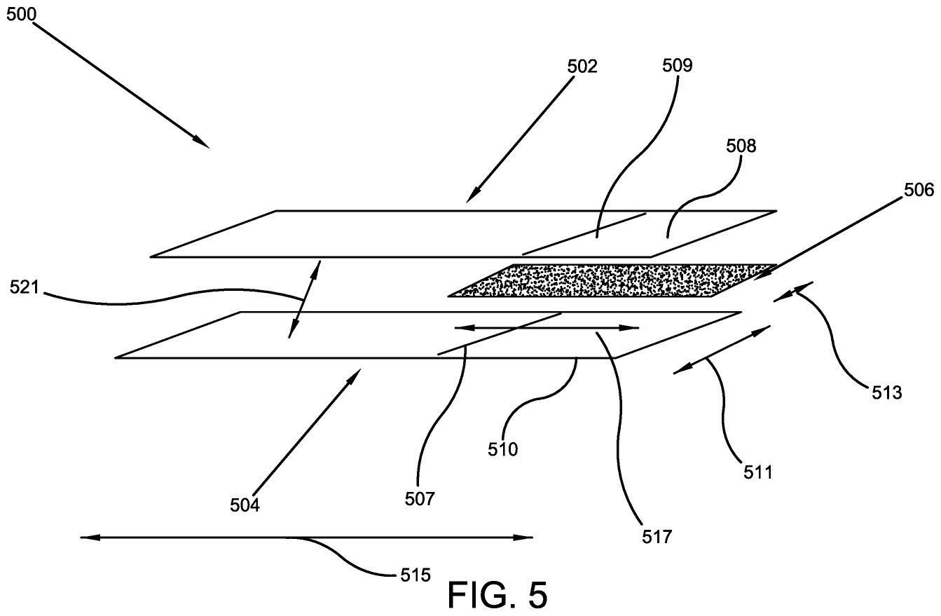

FIG. 5 illustrates a perspective view of yet another potential embodiment of the blanket of the present invention in accordance with the disclosed specification. In the present embodiment, the blanket 500 is comprised of a first outer fabric layer 502 and a second outer fabric layer 504, wherein a filter layer 506 is disposed between the first outer fabric layer 502 and the second outer fabric layer 504 Each of the layers has a length 515 and a width of 511. The filter layer 506 can be a N95, KN95, PM2.5 or any other filtering layer having a width 513 and a length 517, each of which is less than the width and length of the layers 504 and 501. In one embodiment, the filter layer has a width equal to the width of the layers 502, 504, and has a length equal to one-fourth of the length of the fabric layers 502, 504. The layers 502 and 504 may also have positioning assists 507 and 509 to facilitate positioning of the filter layer 506 therebetween. The positioning assists 507 and 509 ensure that the filter layer 506 is positioned over where the face of the child or individual will be positioned. The positioning assists 507 and 509 may also use a fastener, such as a hook loop fastener, adhesive tabs, snaps or other suitable fasteners.

A portion 508 of the first layer 502 and a corresponding portion 510 of the second layer 504 is positioned above and below the filter layer 506, and may have a first color that is different from the second color which may cover the remaining portions of the fabric layers 502, 504. The first color, which is different than the second color, is useful for providing an indication of the position of the filter layer 506, and helps in placing the blanket 500 correctly over a child. The top and bottom layers 502 and 504 form an internal area 521 in which to position the filter layer 506.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “N95 filter lined “cover”, “wrap,” “blanket,” “blanket,” “baby blanket” and “pathogen protecting blanket” are interchangeable and refer to the N95 filter lined blanket, cover or wrap 100, 400, 500 of the present invention.

Notwithstanding the forgoing, the N95 filter lined blanket, cover or wrap 100, 400, 500 of the present invention can be of any suitable size and configuration as is known in the art without affecting the overall concept of the invention, provided that it accomplishes the above stated objectives. One of ordinary skill in the art will appreciate that the N95 filter lined blanket 100, 400, 500 as shown in the FIGS. are for illustrative purposes only, and that many other sizes and shapes of the N95 filter lined blanket 100, 400, 500 are well within the scope of the present disclosure. Although the dimensions of the N95 filter lined blanket, cover or wrap 100, 400, 500 are important design parameters for user convenience, the N95 filter lined blanket, cover or wrap 100, 400, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective cover, comprising:
a top layer comprised of a material;
a bottom layer comprised of a washable material, wherein the top layer and the bottom layer are secured together along a periphery of the top and bottom layers to form an internal area;
an opening provided in at least part of the periphery; and
a filter material inserted between the top layer and bottom layer and within the internal area.

2. The protective cover as recited in claim 1 further comprising a position assist to assist in positioning of the filter material.

3. The protective cover as recited in claim 1, wherein each of the top and bottom layers is provided with a position assist for placement of the filter material.

4. The protective cover as recited in claim 1, wherein a first color is provided on the top layer and a second color is provided on the bottom layer.

5. The protective cover as recited in claim 4, wherein the first color is different than the second color.

6. The protective cover as recited in claim 4, wherein the first color is used for positioning the filter material.

7. The protective cover as recited in claim 1, wherein each of the top layer and bottom layers is comprised of a select one of a microfleece, a cashmere, a cotton, a wool, a stretched polytetrafluoroethylene, a polyester or a linen material.

8. The protective cover as recited in claim 1 further comprising a gauge or an indicator on the top layer.

9. The protective cover as recited in claim 8, wherein the gauge or the indicator indicates a time to replace the filter material.

10. The protective cover as recited in claim 1, wherein the filter material is one of a KN95 material, a N95 material or a PM2.5 material.

11. The protective cover as recited in claim 9, wherein the gauge or the indicator provides a visual indication of the time to change the filter material.

12. The protective cover as recited in claim 9, wherein the gauge or indicator is in wireless communication with a smartphone having a downloaded application.

13. A child blanket comprising:
a top layer comprised of a first color and a second color, wherein the first color is different than the second color;
a bottom layer secured to the top layer along a periphery; and
a filter layer positioned between the top and bottom layers and having a differently sized width and length than a width and a length of each of the top and bottom layers, wherein the filter layer is comprised of a KN95 material, a N95 material or a PM2.5 material.

14. The child blanket as recited in claim 13 further comprising an insulating layer positioned between the top and bottom layers.

15. The child blanket as recited in claim 13 further comprising a positioning assist to aid a user in positioning of the filter layer.

16. The child blanket as recited in claim 13, wherein each of the top layer and the bottom layer are comprised of at least one of a microfleece, a cashmere, a cotton, a wool, a stretched polytetrafluoroethylene, a polyester and a linen material.

17. The child blanket as recited in claim 13, wherein the first color is used to position the filter layer between the top and bottom layers.

18. The child blanket as recited in claim 13 further comprising a visual indicator for determining a time to replace the filter layer.

19. A child carrier and protective blanket for a child comprising:
a child carrier for holding a child;
a blanket comprised of a top layer and a bottom layer secured together along a periphery; and
a filter layer inserted between the top and bottom layers, wherein the filter layer is selected from one of a KN95 material, a N95 material and a PM2.5 material, wherein the blanket is comprised of a first color and a second color that is different from the first color, and further wherein the first color is used for proper positioning of the filter layer.

20. The child carrier and protective blanket for a child as recited in claim 19, wherein the blanket comprises a visual indictor for determining a time to replace the filter layer, and further wherein the periphery comprises an opening for inserting and removing the filter layer from between the top and bottom layer.
